(19) United States
(12) Patent Application Publication
(10) Pub. No.: US 2009/0022187 A1
(43) Pub. Date: Jan. 22, 2009

(54) LASER MODULE

(75) Inventor: Shang-Yi Wu, Hsinchu (TW)

Correspondence Address: J C PATENTS, INC., 4 VENTURE, SUITE 250, IRVINE, CA, 92618, US

(73) Assignee: YOUNG OPTICS INC., Hsinchu, (TW)

(21) Appl. No.: 12/015,363

(22) Filed: Jan. 16, 2008

(30) Foreign Application Priority Data
Jul. 20, 2007 (TW) 96126578

(51) Int. Cl. H01S 3/10

(52) U.S. Cl. 372/21

(57) ABSTRACT

A laser module including at least one light-emitting unit, a filter and a poled nonlinear optical crystal is provided. The light-emitting unit provides an incoherent beam. The filter is disposed on the transmission path of the incoherent beam and reflects at least a part of the incoherent beam. The poled nonlinear optical crystal is disposed on the transmission path of the incoherent beam, and has a plurality of poled portions. The poled portions have a plurality of first poled portions and a plurality of second poled portions which are alternately disposed. The incoherent beam passes through at least a part of the first poled portions and a part of the second poled portions. At least parts of the poled portions have different average widths from each other in the direction parallel to the chief ray of the incoherent beam.

### CROSS-REFERENCE TO RELATED APPLICATION

This application claims the priority benefit of Taiwan application serial no. 96126578, filed on Jul. 20, 2007. The entirety of the above-mentioned patent application is hereby incorporated by reference herein and made a part of this specification.

### BACKGROUND OF THE INVENTION

1. Field of the Invention

The present invention generally relates to a light source module, and more particularly to a laser module.

2. Description of Related Art

Referring to FIG. 1, a conventional semiconductor laser 100 includes a metal electrode layer 110, a semiconductor substrate 120, an N-type semiconductor layer 130, a P-type semiconductor layer 140 and a metal electrode 150 disposed in sequence from bottom to top. When a voltage is applied between the metal electrode layer 110 and the metal electrode 150, the holes from the P-type semiconductor layer 140 and the electrons from the N-type semiconductor layer 130 combine at a P-N junction J to emit a light beam. The both sides of the P-N junction J are two smooth planes S1 and S2, so that the light beam generated in the P-N junction J is reflected back and forth between the two smooth planes S1 and S2. A part of the light beam which resonates and is reflected many times forms into a coherent beam C passing through the smooth plane S1.

In a case that the semiconductor laser 100 serves as a light source in a projection apparatus, a speckle pattern is generated on a screen since the interference of the beam C occurs after the beam C with extreme high time and spatial coherence passes through an optical components with lightly unsmooth surfaces (for example, lens, mirror and the like) in the projection apparatus. The speckle pattern is an irregular noise-like pattern. The speckle phenomenon makes the brightness of projected image frames of the projection apparatus nonuniform, lowers the resolution of image frames and degrades the visual comfort. Besides the semiconductor laser 100, most of other types of lasers, such as solid state laser, gas laser, dye laser and the like also cause speckle phenomenon enough to affect the image frames.

In order to reduce the degree of the speckle phenomenon, the coherent beam C in the above-mentioned projection apparatus is usually designed to pass through a rotating or moving optical component, such as a diffuser, a diffractive optical element or a prism. However, it decreases the intensity of the coherent beam C to utilize the optical component to reduce the degree of the speckle phenomenon. Additionally, the optical component requires an actuator to drive it, which not only increases the cost of the projection apparatus, but also bulks the volume thereof.

### SUMMARY OF THE INVENTION

Accordingly, the present invention is directed to a laser module, which is capable of providing a coherent beam with wider bandwidth so as to effectively reduce the degree of the speckle phenomenon.

Other advantages of the present invention should be further indicated by the disclosures of the present invention.

To achieve one of, a part of or all of the above-mentioned advantages, or to achieve other advantages, one embodiment of the present invention provides a laser module including at least a light-emitting unit, a filter and a poled nonlinear optical crystal. The light-emitting unit provides an incoherent beam. The filter is disposed on a transmission path of the incoherent beam and reflects at least a part of the incoherent beam. An optical cavity is formed between the light-emitting unit and the filter. The poled nonlinear optical crystal is disposed on the transmission path of incoherent beam and located in the optical cavity. The poled nonlinear optical crystal has a plurality of poled portions. The poled portions include a plurality of first poled portions and a plurality of second poled portions. The first poled portions and the second poled portions are alternately disposed. The incoherent beam passes through at least a part of the first poled portions and a part of the second poled portions. At least parts of the poled portions have different average widths from each other in a direction parallel to a chief ray of the incoherent beam, and the electrical dipole moments of the first poled portion and the second poled portion have different directions from each other.

In a laser module of an embodiment of the present invention, after the incoherent beam provided by the light-emitting unit alternately passes through the first poled portions and the second poled portions having a different electrical dipole moment direction from that of the first poled portions, a frequency-multiplied beam having a frequency higher than the incoherent beam is generated. Since at least parts of the poled portions have different average widths from each other in the direction parallel to the chief ray of the incoherent beam, the frequency-multiplied beam passes through the filter to become a coherent beam having a bandwidth wider than that of the conventional laser technology. Since, the coherent beam provided by the laser module according to the embodiment of the present invention has a wider bandwidth, the laser module of the present invention is capable of effectively reducing the degree of the speckle phenomenon.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural diagram of a conventional semiconductor layer.

FIG. 2A is a structural diagram of a laser module according to an embodiment of the present invention.

FIG. 2B is a detail structural diagram of the poled nonlinear optical crystal in FIG. 2A.

FIG. 3 is a detail structural diagram of a poled nonlinear optical crystal in a laser module according to another embodiment of the present invention.

FIG. 4 is a detail structural diagram of a poled nonlinear optical crystal in a laser module according to yet another embodiment of the present invention.

FIG. 5 is a detail structural diagram of a laser module according to still another embodiment of the present invention.

FIG. 6 is a detail structural diagram of a laser module according to yet still another embodiment of the present invention.

FIG. 7 is a detail structural diagram of a laser module according to yet still another embodiment of the present invention.

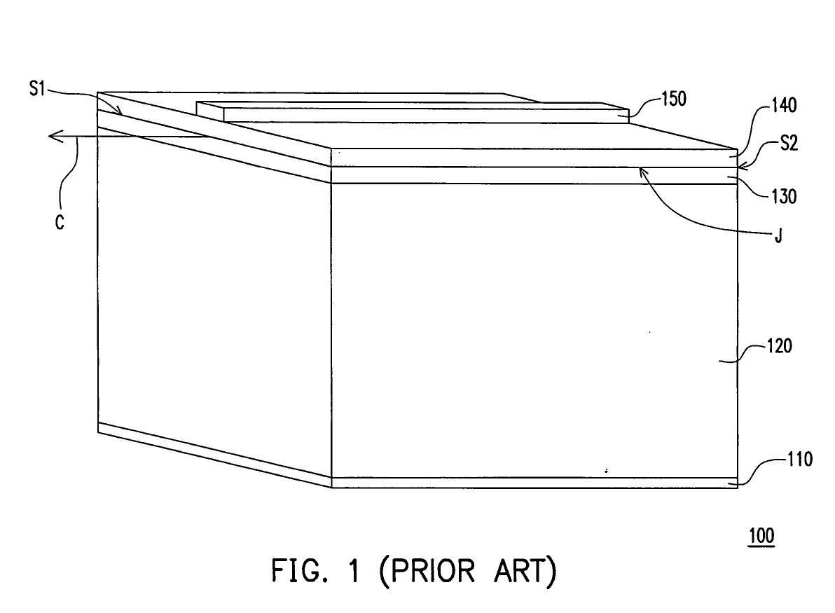

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

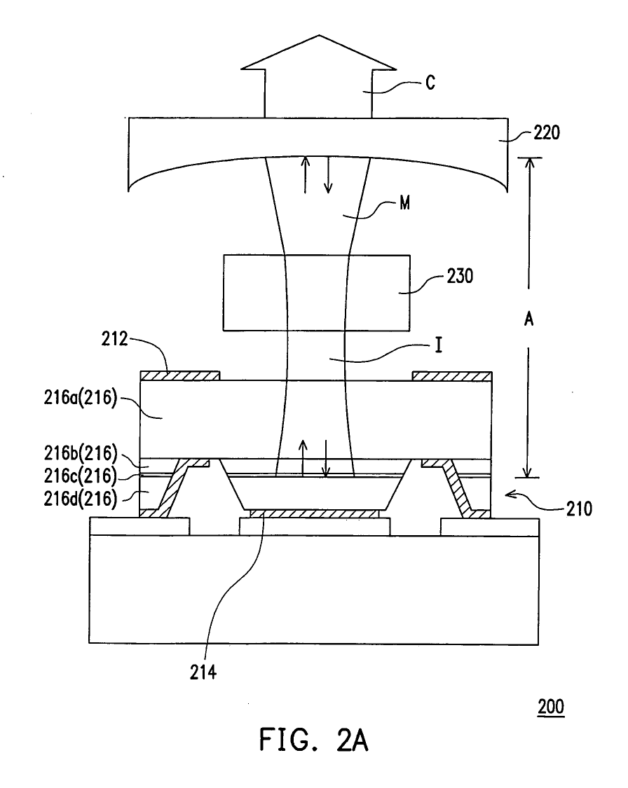

FIG. 2A is a structure diagram of a laser module according to an embodiment of the present invention, and FIG. 2B is a detail structural diagram of the poled nonlinear optical crystal in FIG. 2A. Referring to FIGS. 2A and 2B, a laser module 200 of the present embodiment includes a light-emitting unit 210, a filter 220 and a poled nonlinear optical crystal 230. The light-emitting unit 210 provides an incoherent beam I. In the present embodiment, the light-emitting unit 210 is, for example, a light-emitting diode, which includes an upper electrode 212, a lower electrode 214 and multiple semiconductor layers 216 disposed between the upper electrode 212 and the lower electrode 214. The semiconductor layers 216 includes a substrate 216a, an N-type semiconductor layer 216b, a light-emitting layer 216c and a P-type semiconductor layer 216d which are disposed in sequence from a side close to the upper electrode 212 to another side close to the lower electrode 214. After the holes come from the P-type semiconductor layer 216d and the electrons come from the N-type semiconductor layer 216b are combined, an incoherent beam I is generated and emitted. However, the light-emitting unit 210 in other embodiments may be other light-emitting devices capable of emitting an incoherent beam.

The filter 220 is disposed on a transmission path of the incoherent beam I and reflects at least a part of the incoherent beam I. In the present embodiment, the filter 220 is, for example, a volume Bragg grating. However, in other embodiments, the filter 220 may be a notch filter or other appropriate filters. In addition, an optical cavity A is formed between the light-emitting unit 210 and the filter 220, so that at least a part of the incoherent beam I is able to be reflected back and forth many times between the light-emitting unit 210 and the filter 220 and to resonate to form a coherent beam C passing through the filter 220. In the present embodiment, the coherent beam C is, for example, a laser beam. In more detail of the present embodiment, the optical cavity A is defined between the P-type semiconductor layer 216d and the filter 220, while the P-type semiconductor layer 216d is able to reflect the incoherent beam I.

In the present embodiment, the filter 220 reflects a light beam within a wavelength range between a first wavelength and a second wavelength, wherein the absolute value of the second wavelength minus the first wavelength is greater than 4 nm but less than 8 nm. The wavelength of the incoherent beam I matches the first wavelength and the second wavelength. For example, the wavelength of the incoherent beam I is between the first wavelength and the second wavelength so that the filter 220 reflects the incoherent beam I.

The poled nonlinear optical crystal 230 is disposed on the transmission path of the incoherent beam I and located in the optical cavity A. That is to say, the poled nonlinear optical crystal 230 is disposed between the light-emitting unit 210 and the filter 230. The poled nonlinear optical crystal 230 has a plurality of poled portions 231 (as shown in FIG. 2B). The poled portions 231 include a plurality of first poled portions 232 and a plurality of second poled portions 234. The first poled portions 232 and the second poled portions 234 are alternately disposed. The incoherent beam I passes through at least a part of the first poled portions 232 and a part of the second poled portions 234. At least parts of the poled portions 231 have different average widths from each other in the direction parallel to the chief ray I_{C} of the incoherent beam I, and a direction D1 of an electrical dipole moment of the first poled portions 232 is different from a direction D2 of an electrical dipole moment of the second poled portions 234. In more detail of the present embodiment, the widths W of the poled portions 231 in the direction parallel to the chief ray I_{C} of the incoherent beam I increase gradually from a side adjacent to the filter 220 to another side far away from the filter 220. However, in other embodiments, the widths W may decrease gradually from a side adjacent to the filter 220 to another side far away from the filter 220. Besides, in the embodiment, the direction D1 of the electrical dipole moment is substantially opposite to the direction D2 of the electrical dipole moment. Furthermore, the poled nonlinear optical crystal 230 is, for example, poled lithium niobate crystal, poled potassium titanyl phosphate crystal, or other appropriate poled nonlinear optical crystals.

In the laser module 200 of the embodiment, after the incoherent beam I provided by the light-emitting unit 210 passes through the first poled portions 232 and the second poled portions 234 having the direction D2 of the electrical dipole moment different from the direction D1 of the electrical dipole moment of the first poled portions 232, a frequency-multiplied beam M with a frequency higher than that of the incoherent beam I is generated. Since at least parts of the poled portions 231 have different average widths from each other in the direction parallel to the chief ray I_{C} of the incoherent beam I, the bandwidth of the frequency-multiplied beam M may be wider than that of the coherent beam generated by the conventional laser. A part of the frequency-multiplied beam M is reflected many times and resonates in the optical cavity A, and then passes through the filter 220 to become a coherent beam C with a bandwidth wider than that of the prior art. Since the laser module 200 is capable of providing a coherent beam C with a wavelength wider than that of the prior art, the degree of the speckle phenomenon is effectively reduced when the laser module 200 is applied in a projection apparatus or other optical apparatuses. In addition, since the coherent beam C is generated by resonance of the frequency-multiplied beam M with a frequency higher than that of the incoherent beam I, it is easy for the laser module 200 to obtain the coherent beam C within the visual frequency range.

Additionally, a projection apparatus employing the laser module 200 does not need to adopt another optical component, such as a diffuser, a diffractive optical element, a prism, and the like, for reducing the degree of the speckle phenomenon. Therefore, the intensity of the coherent beam C may not be weakened due to passing the optical component. Accordingly, the projection apparatus employing the laser module 200 is able to project image frames with higher brightness. Moreover, without needing the optical component for reducing the speckle degree and the motor for driving the optical component, the projection apparatus employing the laser module 200 is able to have a smaller volume and less cost.

Generally, the coherent beam provided by a Novalux extended cavity surface emitting laser (NECSEL) with a wavelength of 532 nm has a wavelength range of 532.4 nm-532.6 nm, i.e., a very narrow bandwidth. When the poled nonlinear optical crystal 230 of the embodiment is made of lithium niobate and has the widths W designed within the range of 5.6 μm-6.0 μm (related to operation temperature and material and dependent on the parameters of simulation), and when the incoherent beam I emitted from the light-emitting unit 210 falls within a wavelength range of 1060 nm-1068 nm, the laser module 200 is able to provide a green coherent beam C with a wavelength range of 530 nm-534 nm (i.e. a wider bandwidth). In comparison with the above-mentioned NECSEL, the coherent beam C provided by the laser module 200 of the embodiment has a wavelength range wider by 3.8 nm. The experiments also prove that the wider the wavelength range of a coherent beam is (i.e. the bandwidth is wider), the less the speckle contrast of the produced speckle pattern is, in which the speckle contrast is defined by the result of dividing the standard deviation of the brightness of all the points in the speckle pattern by the average brightness of all points therein. Therefore, the speckle contrast caused by the laser module 200 is 2/9 times the speckle contrast of the NECSEL. In short, the laser module 200 of the embodiment may effectively reduce the degree of the speckle phenomenon.

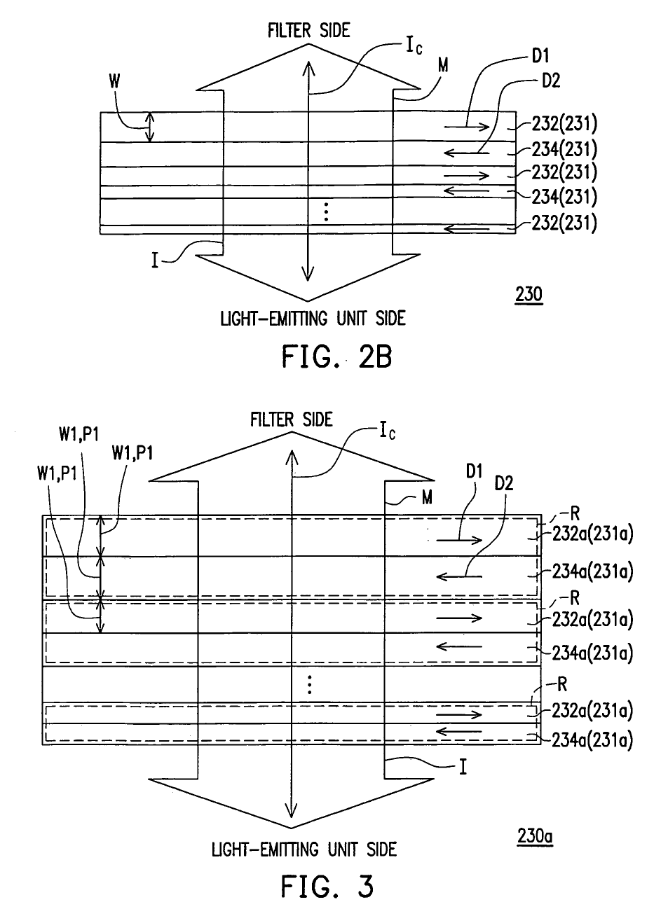

FIG. 3 is a detail structural diagram of a poled nonlinear optical crystal in a laser module according to another embodiment of the present invention. Referring to FIG. 3, in the laser module of the present embodiment, a poled nonlinear optical crystal 230a is adopted instead of the above poled nonlinear optical crystal 230 (referring to FIG. 2B). The poled nonlinear optical crystal 230a is similar to the poled nonlinear optical crystal 230 except that the poled nonlinear optical crystal 230a may be divided into a plurality of blocks R. Poled portions 231a (including first poled portions 232a and second poled portions 234a) in each of the blocks R have the same widths W1 in the direction parallel to the chief ray I_{C} of the incoherent beam I. The blocks R also have width periods P1 respectively, and the width periods P1 of blocks R are different from each other. In the present embodiment, the blocks R are arranged along the chief ray I_{C} of the incoherent beam I, and the width periods P1 of the blocks R decrease gradually from a side adjacent to the filter to another side far away from the filter. However, in other embodiments, the width periods P1 of the blocks R may also increase from a side adjacent to the filter to a side far away from the filter. The laser module adopting the poled nonlinear optical crystal 230a may also achieve the advantages and effects which the above-mentioned laser module 200 (referring to FIG. 2A) has and which will not be repeated herein.

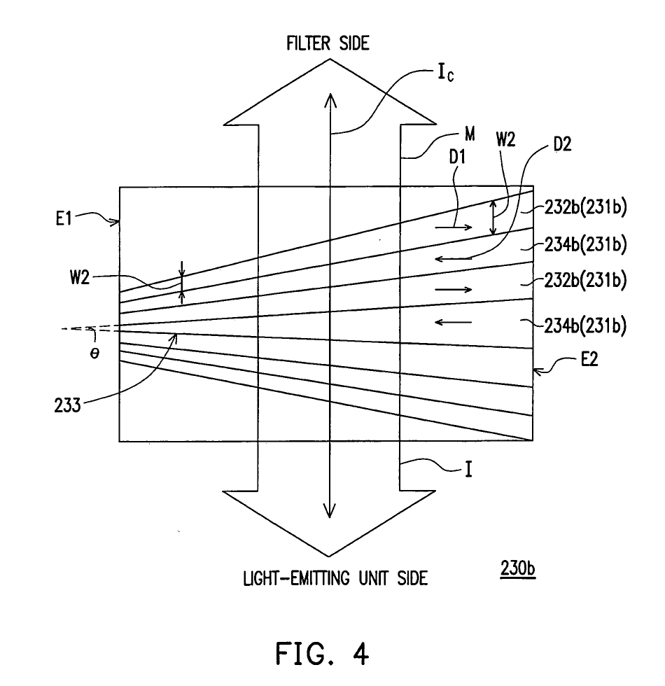

FIG. 4 is a detail structural diagram of a poled nonlinear optical crystal in a laser module according to yet another embodiment of the present invention. Referring to FIG. 4, The poled nonlinear optical crystal 230b is similar to the above-mentioned poled nonlinear optical crystal 230 (referring to FIG. 2B) except for the following differences. The poled nonlinear optical crystal 230b has a first end E1 and a second end E2 opposite to the first end E1, and the first and second ends E1 and E2 are located at two opposite sides of the chief ray I_{C} of the incoherent beam I, respectively. The widths W1 of each of the poled portions 231 (for example, the first or second poled portion 232b or 234b) in the direction parallel to the chief ray I_{C} of the incoherent beam I increase from the first end E1 to the second end E2. However, in other embodiments, the widths W1 of each of the poled portions 231 in the direction parallel to the chief ray I_{C} of the incoherent beam I decrease from the first end E1 to the second end E2 (not shown). In addition, the included angle θ of any two adjacent boundaries 233 of the poled portions 231b is greater than zero degree. In other words, the boundaries 233 are disposed in a fan shape. The laser module adopting the poled nonlinear optical crystal 230b may also achieve the advantages and effects which the above-mentioned laser module 200 (referring to FIG. 2A) has.

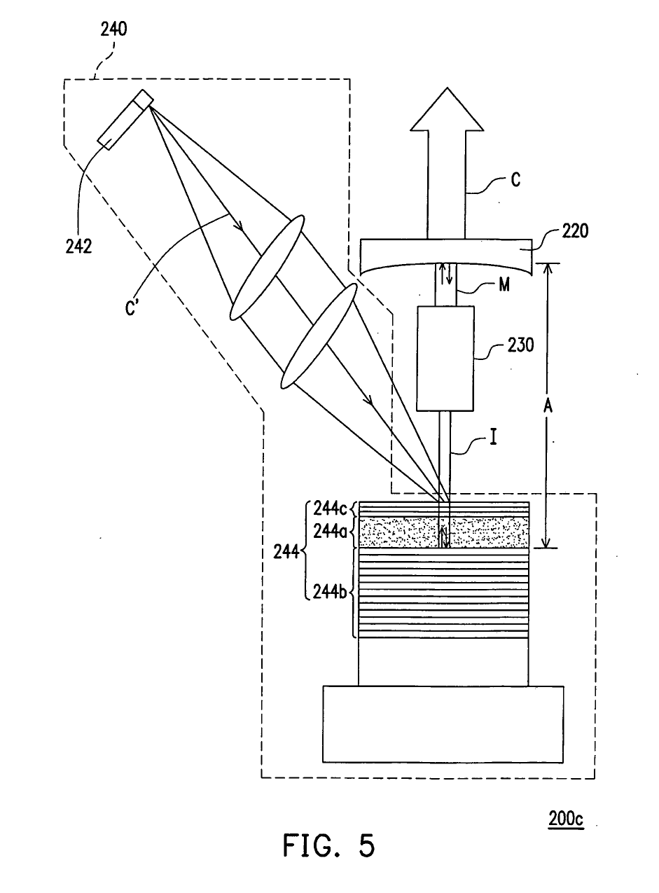

FIG. 5 is a detail structural diagram of a laser module according to still another embodiment of the present invention. The laser module 200c of the present embodiment is similar to the above-mentioned laser module 200 (referring to FIG. 2A) except that the laser module 200c employs the light-emitting unit 240 instead of the above-mentioned light-emitting unit 210 (referring to FIG. 2A). The light-emitting unit 240 includes a laser-emitting device 242 and a photoluminescent device 244. The laser-emitting device 242 emits a coherent beam C′, and the photoluminescent device 244 is disposed on the transmission path of the coherent beam C′ and converts the coherent beam C′ into an incoherent beam I, wherein an optical cavity A is formed between the filter 220 and the photoluminescent device 244.

In more detail of the present embodiment, the photoluminescent device 244 includes a gain medium layer 244a and a reflective layer 244b. The gain medium layer 244a is exited by the coherent beam C′ to emit the incoherent beam I. The gain medium layer 244a is located on the optical path between the reflective layer 244b and the poled nonlinear optical crystal 230. The reflective layer 244b reflects the incoherent beam I emitted from the gain medium layer 244a onto the poled nonlinear optical crystal 230. The reflective layer 244b is, for example, a distributed Bragg reflection layer (DBR layer) or other structures having reflection function. More precisely, the optical cavity A is formed between the reflective layer 244b and the filter 220. In the present embodiment, a partially transmissive and partially reflective layer 244c is disposed on the gain medium layer 244a and on the optical path between the gain medium layer 244a and the poled nonlinear optical crystal 230, in which the reflectance of the partially transmissive and partially reflective layer 244c is much lower than the transmittance thereof so that most of the incoherent beam I is able to pass through the partially transmissive and partially reflective layer 244c. The partially transmissive and partially reflective layer 244c is, for example, a DBR layer with a reflectance much lower than that of the reflective layer 244b or other layers with low reflectance.

It should be noted that the number of the light-emitting units in the laser module 200 or 200c is not limited to one in the present invention. In other embodiments, the laser module 200 or 200c may have a plurality of light-emitting units. Two embodiments are given hereinafter for explaining in detail.

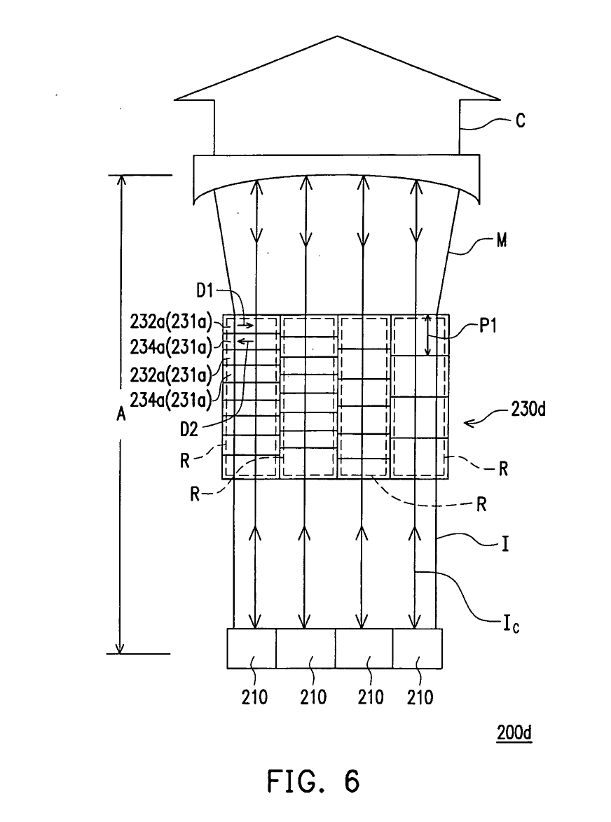

FIG. 6 is a detail structural diagram of a laser module according to yet still another embodiment of the present invention. Referring to FIG. 6, the laser module 200d of the present embodiment is similar to the above-mentioned laser module 200 (referring to FIG. 2A) except for the following differences. The laser module 200d has a plurality of light-emitting units 210. In addition, the laser module 200d employs a poled nonlinear optical crystal 230d instead of the above-mentioned poled nonlinear optical crystal 230 (referring to FIG. 2B). The poled nonlinear optical crystal 230d is similar to the poled nonlinear optical crystal 230a (referring to FIG. 3) except that the blocks R have a different arrangement. In the poled nonlinear optical crystal 230d, the blocks R are disposed on the transmission paths of the incoherent beams I, and arranged transversely with respect to the transmission paths of the incoherent beams I. In this way, the blocks R through which the chief rays I_{C} of at least parts of the incoherent beams I passes are different from each other, and different blocks R have different width periods P1, such that the incoherent beams I are able to be converted into a coherent beam C with a wider bandwidth. In the present embodiment, the chief rays I_{C} of the incoherent beams I respectively pass through the blocks R, so that the chief rays I_{C} of different incoherent beams I may respectively pass through different blocks R. However, in other embodiments, the chief rays I_{C} of several incoherent beams I may pass through the same block R.

Since the laser module 200d of the present embodiment has a plurality of light-emitting units 210 and thus may provide illumination with higher brightness. When the laser module 200d is applied in a projection apparatus, the brightness of the image frames is improved. In addition, the light-emitting units 210 may be arranged in an array or in other appropriate forms. Furthermore, the light-emitting units 210 in the laser module 200d may also be replaced by the above-mentioned light-emitting unit 240 (referring to FIG. 5) or other light-emitting devices capable of emitting incoherent beams.

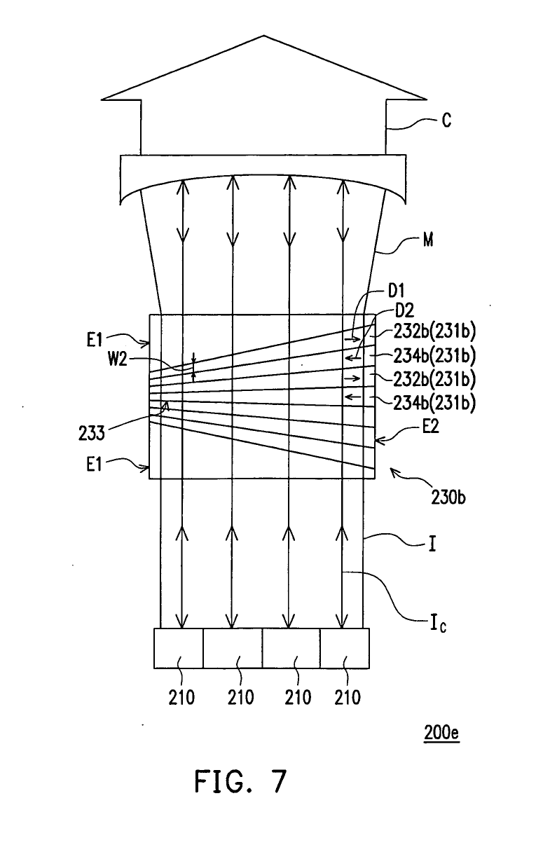

Referring to FIG. 7, in a laser module 200e of yet still another embodiment, the poled nonlinear optical crystal 230d in FIG. 6 is replaced by the above-mentioned poled nonlinear optical crystal 230b. Since the widths W2 increase gradually from the first end E1 to the second end E2, the optical path length in a single poled portion 231b which the chief ray I_{C} closer to the first end E1 travels is shorter than the optical path length therein which the chief ray I_{C} closer to the second end E2 travels. In this way, the incoherent beams I are able to be converted into a coherent beam C with a wider bandwidth.

In summary, in the laser module according to an embodiment of the present invention, after an incoherent beam emitted from the light-emitting unit passes through the first poled portions and the second poled portions, in which at least parts of the first and second poled portions have different average widths, and is reflected many times and resonates in the optical cavity, the incoherent beam may be converted into a coherent beam with a bandwidth wider than that of the prior art. Therefore, when the laser module capable of providing a coherent beam with a wider bandwidth is used in a projection apparatus or other optical apparatuses, the degree of the speckle phenomenon would be effectively reduced.

In addition, a projection apparatus adopting the laser module according to an embodiment of the present invention does not need to employ another optical component, such as a diffuser, a diffractive optical element, a prism, and the like, for reducing the speckle degree. Since the intensity of the coherent beam would not be reduced due to passing through the optical component, the projection apparatus adopting the laser module is able to provide brighter image frames. Furthermore, since any other optical component for reducing speckle degree and the motor for driving the component are not needed, the projection apparatus adopting the laser module is able to have a smaller volume and less cost.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A laser module, comprising:
at least one light-emitting unit for providing an incoherent beam;
a filter, disposed on the transmission path of the incoherent beam and reflecting at least a part of the incoherent beam, wherein an optical cavity is formed between the light-emitting unit and the filter; and
a poled nonlinear optical crystal, disposed on the transmission path of the incoherent beam, located in the optical cavity, and having a plurality of poled portions, wherein the poled portions include a plurality of first poled portions and a plurality of second poled portions, the first poled portions and the second poled portions are alternately disposed, the incoherent beam passes through at least a part of the first poled portions and at least a part of the second poled portions, at least parts of the poled portions have different average widths from each other in a direction parallel to a chief ray of the incoherent beam, and a direction of an electrical dipole moment of the first poled portions is different from a direction of an electrical dipole moment of the second poled portions.

2. The laser module according to claim 1, wherein the light-emitting unit comprises a light-emitting diode.

3. The laser module according to claim 1, wherein the light-emitting unit comprises:
a laser-emitting device for emitting a coherent beam; and
a photoluminescent device, disposed on a transmission path of the coherent beam and converting the coherent beam into the incoherent beam, wherein the optical cavity is formed between the filter and the photoluminescent device.

4. The laser module according to claim 3, wherein the photoluminescent device comprises:
a gain medium layer, excited by the coherent beam to emit the incoherent beam; and
a reflective layer, wherein the gain medium layer is located on an optical path between the reflective layer and the poled nonlinear optical crystal, and the reflective layer reflects the incoherent beam emitted from the gain medium layer to the poled nonlinear optical crystal.

5. The laser module according to claim 4, wherein the reflective layer is a distributed Bragg reflection layer.

6. The laser module according to claim 1, wherein the direction of the electrical dipole moment of the first poled portions is opposite to the direction of the electrical dipole moment of the second poled portions.

7. The laser module according to claim 1, wherein widths of the poled portions in the direction parallel to the chief ray of the incoherent beam increase or decrease gradually from a side adjacent to the filter to another side far away from the filter.

8. The laser module according to claim 1, wherein the poled nonlinear optical crystal is divided into a plurality of blocks, widths of the poled portions in the direction parallel to the chief ray of the incoherent beam in each of the blocks are the same, the blocks have width periods respectively, and the width periods of the blocks are different from each other.

9. The laser module according to claim 8, wherein the blocks are arranged along the chief ray of the incoherent beam, and the width periods of the blocks increase or decrease gradually from a side adjacent to the filter to another side far away from the filter.

10. The laser module according to claim 8, wherein the at least one light-emitting unit is a plurality of light-emitting units, the blocks are disposed on transmission paths of the incoherent beams and arranged transversely with respect to the transmission paths of the incoherent beams.

11. The laser module according to claim 10, wherein chief rays of the incoherent beams passes through the blocks, respectively.

12. The laser module according to claim 1, wherein the poled nonlinear optical crystal has a first end and a second end opposite to the first end, the first end and the second end are respectively located at two opposite sides of the chief ray of the incoherent beam, and widths of each of the poled portions in the direction parallel to the chief ray of the incoherent beam increase or decrease gradually from the first end to the second end.

13. The laser module according to claim 12, wherein an included angle between any two adjacent boundaries of the poled portions is greater than zero degree.

14. The laser module according to claim 1, wherein the filter is a volume Bragg grating or a notch filter.

15. The laser module according to claim 1, wherein the filter is capable of reflecting a light beam within a wavelength range between a first wavelength and a second wavelength, and an absolute value of the second wavelength minus the first wavelength is greater than 4 nm but less than 8 nm.
